(19) United States
(12) Patent Application Publication
(10) Pub. No.: US 2023/0284007 A1
(43) Pub. Date: Sep. 7, 2023

(54) COMMUNICATION METHOD, DEVICE, AND STORAGE MEDIUM

(71) Applicant: Spreadtrum Communications (Shanghai) Co., Ltd., Shanghai (CN)

(72) Inventors: Yan Zhang, Shanghai (CN); Haifeng Wu, Shanghai (CN)

(21) Appl. No.: 18/006,388

(22) PCT Filed: Jun. 8, 2021
(86) PCT No.: PCT/CN2021/099010

§ 371 Date: Jan. 22, 2023

(30) Foreign Application Priority Data
Jul. 23, 2020 (CN) 202010718064.0

(51) Int. Cl. H04W 8/06; H04W 8/24; H04W 76/10; H04W 60/00

(52) U.S. Cl. CPC H04W 8/06; H04W 8/24; H04W 60/00; H04W 76/10

(57) ABSTRACT

The present application provides a communication method, a device, and a storage medium. The method includes: sending, by a terminal device, a request message to a network device, where the request message includes capability information of the terminal device in supporting assisted location; and receiving, by the terminal device, a response message sent by the network device, where the response message includes address information of an assisted location server. According to the method of the embodiments of the present application, an address of an available assisted location server may be obtained by interaction between a terminal device and a network device.

### CROSS-REFERENCE TO RELATED APPLICATIONS

This application is a national stage of International Application No. PCT/CN2021/099010, filed on Jun. 08, 2021, which claims priority to Chinese Patent Application No. 202010718064.0, filed on Jul. 23, 2020, both of which are hereby incorporated by reference in their entireties.

### TECHNICAL FIELD

The present disclosure relates to the technical field of communication, and particularly to a communication method, a device, and a storage medium.

### BACKGROUND

With the development of communication technology, a current terminal device (such as a smartphone, etc.) generally has a location function, and an assisted location function also makes a location effect of the terminal device with better. The assisted location function of the terminal device has to rely on a server that provides assisted location data for the terminal device, and operators in different regions may choose different assisted location servers, where the different assisted location servers are used for transmitting assisted location data between the terminal device and the assisted location servers.

When assisted location is implemented, the terminal device is required to obtain an address of the assisted location server, thereby interacting with the assisted location server to obtain assisted location data. In the related art, the terminal device stores an address of one or more assisted location servers in advance. If an address of only one assisted location server is stored, the assisted location server may not be universal. If addresses of multiple assisted location servers are stored, but these addresses may not all be available in a current network, and the terminal device may sequentially try to be connected to each server until finding an available server, which may affect the assisted location efficiency. Therefore, how to obtain an address of an available assisted location server in a current network is a technical problem urgent to be solved by those skilled in the art.

### SUMMARY

The present disclosure provides a communication method, a device, and a storage medium. A terminal device may obtain an address of an available assisted location server in a current network.

According to a first aspect, the present disclosure provides a communication method, including:
sending, by a terminal device, a request message to a network device, where the request message includes capability information of the terminal device in supporting assisted location; and
receiving, by the terminal device, a response message sent by the network device, where the response message includes address information of an assisted location server.

According to a second aspect, the present disclosure provides a communication method, including:
receiving, by a network device, a request message sent by a terminal device, where the request message includes capability information of the terminal device in supporting assisted location; and
sending, by the network device, a response message to the terminal device, where the response message includes address information of an assisted location server.

According to a third aspect, the present disclosure provides a terminal device, including:
a sending module, configured to send a request message to a network device, where the request message includes capability information of the terminal device in supporting assisted location; and
a receiving module, configured to receive a response message sent by the network device, where the response message includes address information of an assisted location server.

According to a fourth aspect, the present disclosure provides a network device, including:
a receiving module, configured to receive a request message sent by a terminal device, where the request message includes capability information of the terminal device in supporting assisted location; and
a sending module, configured to send a response message to the terminal device, where the response message includes address information of an assisted location server.

According to a fifth aspect, an embodiment of the present disclosure provides a computer-readable storage medium, storing a computer program which, when executed by a processor, implements the methods as described in any one of the first aspect and the second aspect.

According to a sixth aspect, an embodiment of the present disclosure provides a terminal device, including:
a processor, a memory, and an interface for communication with a network device;
where the memory stores a computer-executable instruction; and
the processor executes the computer-executable instruction stored in the memory to enable the processor to perform the method as described in any one of the first aspect.

According to a seventh aspect, an embodiment of the present disclosure provides a network device, including:
a processor, a memory, and an interface for communication with a terminal device;
where the memory stores a computer-executable instruction; and
the processor executes the computer-executable instruction stored in the memory to enable the processor to perform the communication method as described in any one of the second aspect.

### BRIEF DESCRIPTION OF DRAWINGS

The accompanying drawings, which are incorporated in and constitute a part of this specification, illustrate embodiments consistent with the present disclosure and, together with the specification, serve to explain the principle of the present disclosure.

FIG. 1 is a schematic flowchart of an embodiment of a communication method according to the present disclosure.

FIG. 2 is a schematic interactive flowchart of a 5th-Generation (5G) system in an embodiment of a communication method according to the present disclosure.

FIG. 3 is a schematic interactive flowchart of a 4th-Generation (4G) system in an embodiment of a communication method according to the present disclosure.

FIG. 4 is a schematic interactive flowchart of a 2nd-Generation (2G)/3rd-Generation (3G) system in an embodiment of a communication method according to the present disclosure.

FIG. 5 is a schematic interactive flowchart of a 5G system in another embodiment of a communication method according to the present disclosure.

FIG. 6 is a schematic interactive flowchart of a 4G system in another embodiment of a communication method according to the present disclosure.

FIG. 7 is a schematic interactive flowchart of a 2G/3G system in another embodiment of a communication method according to the present disclosure.

FIG. 8 is a schematic flowchart of another embodiment of a communication method according to the present disclosure.

FIG. 9 is a structural diagram of an embodiment of a terminal device according to the present disclosure.

FIG. 10 is a structural diagram of an embodiment of a network device according to the present disclosure.

FIG. 11 is a structural diagram of another embodiment of a terminal device according to the present disclosure.

FIG. 12 is a structural diagram of another embodiment of a network device according to the present disclosure.

Specific embodiments of the present disclosure have been shown in the drawings, and more detailed descriptions will be made hereinafter. These drawings and text descriptions are not for limiting the scope of the concept of the present disclosure in any manner but for explaining the concept of the present disclosure to those skilled in the art with reference to the specific embodiments.

### DESCRIPTION OF EMBODIMENTS

Exemplary embodiments will now be described in detail, examples of which are represented in the drawings. When the following descriptions involve the drawings, the same numerals in different drawings represent the same or similar elements, unless otherwise indicated. Implementations described in the following exemplary embodiments do not represent all Implementations consistent with the present disclosure. Instead, they are merely examples of an apparatus and method consistent with some aspects of the present disclosure described in detail in the appended claims.

Terms “include” and “have” in the specification, claims, and drawings of the present disclosure and any transformation thereof are intended to cover nonexclusive inclusions. For example, a process, method, system, product, or device including a series of steps or units is not limited to the listed steps or units but optionally further includes steps or units which are not listed, or optionally further includes other steps or units intrinsic to the process, the method, the product, or the device.

First of all, terms and application scenarios involved in the present disclosure are introduced.

In the embodiments of the present disclosure, a terminal device may refer to various User Equipment (UE), an access terminal, a user unit, a user station, a mobile radio station, a Mobile Station (MS), a remote station, a remote terminal, a mobile device, a user terminal, terminal equipment, a wireless communication device, a user agent, or a user apparatus. The terminal device may also be a cell phone, a cordless phone, a Session Initiation Protocol (SIP) phone, a Wireless Local Loop (WLL) station, a Personal Digital Assistant (PDA), a handheld device with a wireless communication function, a computing device or other processing devices connected to a wireless modem, a vehicle device, a wearable device, a terminal device in a future 5G network, or a terminal device in a future evolved Public Land Mobile Network (PLMN), etc. No limits are made thereto in the embodiments of the present disclosure.

In the embodiments of the present disclosure, a network device may include network element in a communication network (such as a radio access network or a core network), such as a Mobility Management Entity (MME) in a core network in 4G network, an Access and Mobility Management Function (AMF) and Session Management Function (SMF) in 5G New Radio (NR), and a network device in a future new communication system, etc.

An assisted location function of a terminal device has to rely on a server that provides assisted location data for the terminal device, and operators in different regions may choose different assisted location servers, where the different assisted location servers are used for transmitting assisted location data between the terminal device and the assisted location servers.

In some embodiments, the assisted location server is an assisted location server that follows a Secure User Plane Location (SUPL) protocol. The SUPL protocol is formulated by the Open Mobile Alliance (OMA).

For a network, the input cost of the SUPL protocol is low, and a corresponding SUPL server may be constructed based on a Transmission Control Protocol (TCP)/Internet Protocol (IP) network. Therefore, the SUPL protocol is used extensively.

In the related art, a terminal device may obtain an SUPL server address in the following several manners.

A Subscriber Identity Module (SIM) card may store an SUPL server address provided by a corresponding operator. However, most issued SIM cards do not provide SUPL server addresses.

A terminal device may store a one or more SUPL server addresses when leaving the factory. However, most terminal devices do not store SUPL server address. Even though there are stored SUPL server addresses, if only one address is stored, it is likely that this address is not universal because of laws and regulations (for example, supl.google.com is unavailable in the mainland of China, etc.). If multiple addresses are stored, the terminal device may sequentially try to be connected to each server until finding an available server in the current network, which may affect the overall Time To First Fix (TTFF).

The TTFF refers to time from first event-based triggering of determining location related data to obtaining the location related data at a positioning system interface.

In summary, in actual applications, how to obtain an available SUPL server address meeting requirement in a current network is a technical problem to be solved.

According to a method of the embodiments of the present disclosure, a terminal device is registered in a network to obtain an address of an assisted location server provided by the current network. That is, the terminal device obtains an address of an assisted location server by interaction with a network device of the current network.

The technical solution of the present disclosure will be described below in detail with specific embodiments. The following several specific embodiments may be combined with one another. The same or similar concepts or processes will not be elaborated in some embodiments.

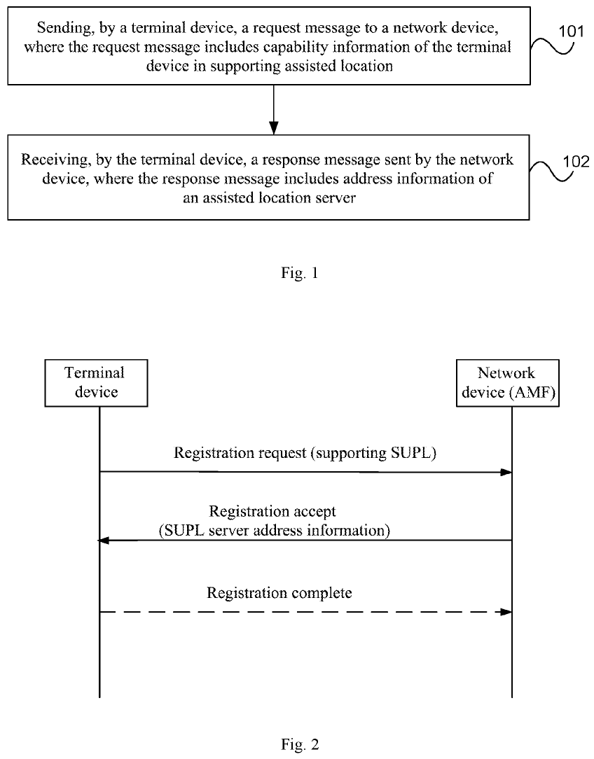

FIG. 1 is a schematic flowchart of an embodiment of a communication method according to the present disclosure. As shown in FIG. 1, the method provided in the present embodiment includes the following steps.

In S101, sending, by a terminal device, a request message to a network device, where the request message includes capability information of the terminal device in supporting assisted location.

Specifically, a terminal device, before requesting an assisted location server for assisted location data, sends capability information of supporting assisted location to a network device to inform the network device that the terminal device has a capability of supporting assisted location such that the network device sends address information of the assisted location server to the terminal device.

The terminal device interacts with the assisted location server for assisted location according to the address information of the assisted location server.

In an embodiment, assisted location follows an SUPL protocol.

In S102, receiving, by the terminal device, a response message sent by the network device, where the response message includes address information of an assisted location server.

Specifically, the network device, after receiving the request of the terminal device, learns that the terminal device has the capability of supporting assisted location, and sends a response message including the address information of the assisted location server to the terminal device.

The terminal device obtains an address of the assisted location server provided by a network side through a network where it is registered, and is connected with the assisted location server to obtain the assisted location data.

The address information of the assisted location server may include an address of one or more assisted location servers. The terminal device selects one assisted location server, and is connected with the assisted location server to obtain the assisted location data.

If the network changes or receives an address of a new assisted location server, it is required to connect other assisted location servers again.

The address of the assisted location server provided by the network side is not limited to be provided by an operator, and may also be a public server address of a corresponding country/region.

According to the method of the present embodiment, the terminal device initiates a request to the network side to obtain the address of the assisted location server provided by the current network. That is, the terminal device obtains an address of an available assisted location server in the current network by interaction with the network device of the current network. Therefore, the efficiency is relatively high.

Based on the above-mentioned embodiment, the terminal device may obtain the address of the assisted location server provided by the network through the network where it is registered in multiple signaling interaction processes. For example, the terminal device obtains the address of the available assisted location server from the network side by interaction with the network device during registration to the wireless network or after successful registration.

In an embodiment, S101 may be implemented in the following manners:
sending, by the terminal device, the request message to the network device during network registration; or,
sending, by the terminal device, the request message to the network device after successful network registration.

Specifically, the terminal device informs the network side that the terminal device supports assisted location, such as supporting the SUPL protocol, when initiating a registration request.

The network learns from the received registration request that the terminal device supports assisted location, and then may add the address of the assisted location server that the network side expects the terminal device to use to a registration accept message.

Alternatively, the terminal device initiates a request to the network side after successful network registration, namely after registered to the wireless network. For example, the request is initiated during PDU session establishment or in other processes.

In an embodiment, the request message includes indication information, where the indication information is used for indicating that the terminal device supports assisted location, namely the terminal device has the capability of supporting assisted location.

In an embodiment, S102 may be implemented in the following manners:
receiving, by the terminal device, the response message sent by the network device during network registration; or,
receiving, by the terminal device, the response message sent by the network device after successful network registration.

In summary, the terminal device may interact with the network device during network registration to obtain the address of the assisted location server. Alternatively, the terminal device may interact with the network device after successful network registration to obtain the address of the assisted location server. Alternatively, the two processes may be combined. For example, the terminal device informs the network side that “the terminal supports assisted location” through the request message initiated for registration, and the network side sends the address of the assisted location server to the terminal device after subsequent network registration succeeds.

In other embodiments, the network side may actively send the address of the assisted location server to the terminal device through a specific message.

In the above-mentioned implementation, the terminal device may obtain the address of the assisted location server provided by the network through the network where it is registered in multiple signaling interaction processes. For example, the terminal device obtains the address of the available assisted location server from the network side by interaction with the network device during registration to the wireless network or after successful registration. Therefore, the flexibility is relatively high and operation is convenient.

In an embodiment, the address information of the assisted location server may be represented by an address information list.

In an embodiment, the address information of the assisted location server includes a length of the address information, an address of at least one assisted location server, and a length of the address of each assisted location server.

Specifically, the address information of the assisted location server sent by the network side may include an address of one or more assisted location servers, and may further include a total length of the address information, such as the number of bytes of the length, and a length of the address of each assisted location server.

In an embodiment, the method further includes the following steps:
determining, by the terminal device, address information of a target assisted location server according to the address information of the assisted location server; and
requesting, by the terminal device, the target assisted location server for assisted location data according to the address information of the target assisted location server.

Specifically, if addresses of multiple assisted location servers are included, the terminal device may select a target assisted location server according to a sequence of the address of each assisted location server in the address information, and establish a connection with the target assisted location server. The address of each assisted location server included in the address information may be sequenced by priority.

Alternatively, the terminal device may select a target assisted location server according to a priority of the address of each assisted location server, and establish a connection with the target assisted location server.

Further, the address information further includes priority information corresponding to each assisted location server.

The terminal device determines address information of the target assisted location server according to the address of the at least one assisted location server and the priority information corresponding to each assisted location server.

In an embodiment, the terminal device may select an address of a target assisted location server according to a priority sequence, for example, selecting from addresses of assisted location servers stored in a SIM card, or selecting from addresses of assisted location servers sent by the network side, or selecting from addresses of assisted location servers stored in the terminal device.

For example, it is first selected from the addresses of the assisted location servers stored in the SIM card, if no, a request is initiated to the network side to obtain the addresses of the assisted location servers sent by the network side to select from the addresses of the assisted location servers sent by the network side.

If the address of assisted location server sent by the network side is not received, it is selected from the addresses of the assisted location servers stored in the terminal device.

In the above-mentioned implementation, the terminal device selects the address of the available assisted location server from the addresses of the assisted location servers provided by the network side, so that the operation is convenient and the efficiency is relatively high.

In an embodiment, there are specifically the following several scenarios when the terminal device interacts with the network device to obtain the address of the assisted location server during registration to the network device.

For a 5G system, as shown in FIG. 2, the request message is a registration request (REGISTRATION REQUEST), and the response message is a registration accept (REGISTRATION ACCEPT). The network device is, for example, an AMF unit.

For example, indication information is added to an information element (IE) 5G Mobile Management (MM) capability of the REGISTRATION REQUEST message to indicate that the terminal device supports assisted location, i.e., an SUPL standard. A length of the indication information is, for example, 1 bit, as shown by an SUPL field in the following Table 1. For example, if the SUPL field is 1, it indicates that assisted location is supported; and if the SUPL field is 0, it indicates that assisted location is not supported.

TABLE 1

| 8 | 7 | 6 | 5 | 4 | 3 | 2 | 1 | |
|---|---|---|---|---|---|---|---|---|
| 5GMM capability IEI | | | | | | | | octet 1 |
| Length of 5GMM capability contents | | | | | | | | octet 2 |
| SGC | 5G-HC-CP CIoT | N3 data | 5G-CP CIoT | RestrictEC | LPP | HO Attach | S1 mode | octet 3 |
| RACS | NSSAA | 5G-LCS | V2X CNP C5 | V2X CEP C5 | V2X | 5G-UP CIoT | 5GS RVCC | octet 4* |
| 0 | 0 | 0 | 0 | 0 | SUPL | WUSA | CAG | octet 5* |
| 0 | 0 | 0 | 0 | 0 | 0 | 0 | 0 | octet 6*-15* |
| Spare | | | | | | | | |

IEI represents IE identifier.

For example, an IE is added to the REGISTRATION ACCEPT, and the address of the assisted location server (such as an SUPL server address) provided by the network side is sent to the terminal device.

In the following Table 2, TLV format represents type-length-value, and O represents OPTION.

For example, the IE identifier is XX, and a content of the IE is address information of an assisted location server, such as a preferred assisted location server address list. A total length of the address information is, for example, 7 to 100 bytes, or other lengths. No limits are made thereto in the embodiment of the present disclosure.

A format of the address information of the assisted location server is specifically as shown in Table 3. In Table 3, the address information of the assisted location server includes a total length of the address list, an address of each assisted location server, and a length of the address of each assisted location server.

TABLE 2

| IEI | Information Element | Type/Reference | Presence | Format | Length |
|---|---|---|---|---|---|
| | Extended protocol discriminator | Extended protocol discriminator 9.2 | M | V | 1 |
| | Security header type | Security header type 9.3 | M | V | ½ |
| | Spare half octet | Spare half octet 9.5 | M | V | ½ |
| | Registration accept message identity | Message type 9.7 | M | V | 1 |
| | 5GS registration result | 5GS registration result 9.11.3.6 | M | LV | 2 |
| 77 | 5G-GUTI | 5GS mobile identity 9.11.3.4 | O | TLV-E | 14 |
| 4A | Equivalent PLMNs | PLMN list 9.11.3.45 | O | TLV | 5-47 |
| 54 | TAI list | 5GS tracking area identity list 9.11.3.9 | O | TLV | 9-114 |
| 15 | Allowed NSSAI | NSSAI 9.11.3.37 | O | TLV | 4-74 |
| 11 | Rejected NSSAI | Rejected NSSAI 9.11.3.46 | O | TLV | 4-42 |
| 31 | Configured NSSAI | NSSAI 9.11.3.37 | O | TLV | 4-146 |
| 21 | 5GS network feature support | 5GS network feature support 9.11.3.5 | O | TLV | 3-5 |
| 50 | PDU session status | PDU session status 9.11.3.44 | O | TLV | 4-34 |
| 26 | PDU session reactivation result | PDU session reactivation result 9.11.3.42 | O | TLV | 4-34 |
| 72 | PDU session reactivation result error cause | PDU session reactivation result error cause 9.11.3.43 | O | TLV-E | 5-515 |
| 79 | LADN information | LADN information 9.11.3.30 | O | TLV-E | 12-171 5 |
| B- | MICO indication | MICO indication 9.11.3.31 | O | TV | 1 |
| 9- | Network slicing indication | Network slicing indication 9.11.3.36 | O | TV | 1 |
| 27 | Service area list | Service area list 9.11.3.49 | O | TLV | 6-114 |
| 5E | T3512 value | GPRS timer 3 9.11.2.5 | O | TLV | 3 |
| 5D | Non-3GPP de-registration timer value | GPRS timer 2 9.11.2.4 | O | TLV | 3 |
| 16 | T3502 value | GPRS timer 2 9.11.2.4 | O | TLV | 3 |
| 34 | Emergency number list | Emergency number list 9.11.3.23 | O | TLV | 5-50 |
| 7A | Extended emergency number list | Extended emergency number list 9.11.3.26 | O | TLV-E | 7-6553 8 |
| 73 | SOR transparent container | SOR transparent container 9.11.3.51 | O | TLV-E | 20-n |
| 78 | EAP message | EAP message 9.11.2.2 | O | TLV-E | 7-1503 |
| A- | NSSAI inclusion mode | NSSAI inclusion mode 9.11.3.37A | O | TV | 1 |
| 76 | Operator-defined access category definitions | Operator-defined access category definitions 9.11.3.38 | O | TLV-E | 3-n |
| 51 | Negotiated DRX parameters | 5GS DRX parameters 9.11.3.2A | O | TLV | 3 |
| D- | Non-3GPP NW policies | Non-3GPP NW provided policies 9.11.3.36A | O | TV | 1 |
| 60 | EPS bearer context status | EPS bearer context status 9.11.3.23A | O | TLV | 4 |
| 6E | Negotiated extended DRX parameters | Extended DRX parameters 9.11.3.26A | O | TLV | 3 |
| 6C | T3447 value | GPRS timer 3 9.11.2.5 | O | TLV | 3 |
| 6B | T3448 value | GPRS timer 3 9.11.2.4 | O | TLV | 3 |
| 6A | T3324 value | GPRS timer 3 9.11.2.5 | O | TLV | 3 |
| 67 | UE radio capability ID | UE radio capability ID 9.11.3.68 | O | TLV | 3-n |
| 68 | UE radio capability ID deletion indication | UE radio capability ID deletion indication 9.11.3.69 | O | TV | 1 |
| 39 | Pending NSSAI | NSSAI 9.11.3.37 | O | TLV | 4-74 |
| 74 | Ciphering key data | Ciphering key data 9.11.3.18C | O | TLV-E | x-n |
| 75 | CAG information list | CAG information list 9.11.3.18A | O | TLV-E | 3-n |
| 1B | Truncated 5G-S-TMSI configuration | Truncated 5G-S-TMSI configuration 9.11.3.70 | O | TLV | 3 |
| 1C | Negotiated WUS assistance information | WUS assistance information 9.11.3.71 | O | TLV | 3-n |
| XX | Preferred SUPL server address list | SUPL server address list YY | O | TLV | 7-100 |

TABLE 3

| | | | | | | | | |
|---|---|---|---|---|---|---|---|---|
| 8 | 7 | 6 | 5 | 4 | 3 | 2 | 1 | |
| SUPL server address list IEI | | | | | | | | octet 1 |
| Length of SUPL server address list IE contents | | | | | | | | octet 2 |
| Length of 1^{st} SUPL server address | | | | | | | | octet 3 |
| SUPL server address | | | | | | | | octet 3+1* octet j-1* |
| Length of 2^{nd} SUPL server address | | | | | | | | octet j * |
| SUPL server address | | | | | | | | octet j+1* octet k-1 * |
| ... | | | | | | | | |
| Length of xth SUPL server address | | | | | | | | octet n* |
| SUPL server address | | | | | | | | octet n+ 1 *octet o* |

For a 4G system, as shown in FIG. 3, the request message is an attach request (ATTACH REQUEST), and the response message is an attach accept (ATTACH ACCEPT). The network device is, for example, an MME.

For example, indication information is added to an IE UE network capability of the ATTACH REQUEST message to indicate that the terminal device supports assisted location, such as supporting an SUPL standard. A length of the indication information is, for example, 1 bit, as shown by an SUPL field in the following Table 4. For example, if the SUPL field is 1, it indicates that assisted location is supported; and if the SUPL field is 0, it indicates that assisted location is not supported.

TABLE 4

| 8 | 7 | 6 | 5 | 4 | 3 | 2 | 1 | |
|---|---|---|---|---|---|---|---|---|
| UE network capability IEI | | | | | | | | octet 1 |
| NNLength of UE network capability contents | | | | | | | | octet 2 |
| EEA 0 | 128-EEA 1 | 128-EEA 2 | 128-EEA 3 | EEA 4 | EEA5 | EEA 6 | EEA 7 | octet 3 |
| EIA0 | 128-EIA1 | 128-EIA2 | 128-EIA3 | EIA4 | EIA5 | EIA6 | EIA7 | octet 4 |
| UEA 0 | UEA 1 | UEA 2 | UEA 3 | UEA 4 | UEA5 | UEA 6 | UEA 7 | octet 5* |
| UCS 2 | UIA1 | UIA2 | UIA3 | UIA4 | UIA5 | UIA6 | UIA7 | octet 6* |
| ProS e-dd | ProS e | H.24 5-AS H | ACC -CSF B | LPP | LCS | 1xSR VCC | NF | octet 7* |
| ePC O | HC-CP CIoT | ERw/ oPD N | S1-U data | UP CIoT | CP CIoT | Prose -relay | ProS e-dc | octet 8* |
| 15 beare rs | SGC | N1m ode | DCN R | CP back off | Restric tEC | V2X PC5 | multi pleD RB | octet 9* |
| 0 Spare | 0 Spare | 0 Spare | 0 Spare | 0 Spare | SUPL | WUS A | RAC S | octet 10* |
| 0 0 0 0 0 0 0 0 Spare | | | | | | | | octet 11 * -15* |

For example, an IE is added to the ATTACH ACCEPT, and the address of the assisted location server provided by the network is sent to the terminal device, referring to the following Table 5. This situation is like the 5G system, and elaborations are omitted herein.

TABLE 5

| IEI | Information Element | Type/Reference | Presence | Format | Length |
|---|---|---|---|---|---|
| | Protocol discriminator | Protocol discriminator 9.2 | M | V | ½ |
| | Security header type | Security header type 9.3.1 | M | V | ½ |
| | Attach accept message identity | Message type 9.8 | M | V | 1 |
| | EPS attach result | EPS attach result 9.9.3.10 | M | V | ½ |
| | Spare half octet | Spare half octet 9.9.2.9 | M | V | ½ |
| | T3412 value | GPRS timer 9.9.3.16 | M | V | 1 |
| | TAI list | Tracking area identity list 9.9.3.33 | M | LV | 7-97 |
| | ESM message container | ESM message container 9.9.3.15 | M | LV-E | 5-n |
| 50 | GUTI | EPS mobile identity 9.9.3.12 | O | TLV | 13 |
| 13 | Location area identification | Location area identification 9.9.2.2 | O | TV | 6 |
| 23 | MS identity | Mobile identity 9.9.2.3 | O | TLV | 7-10 |
| 53 | EMM cause | EMM cause 9.9.3.9 | O | TV | 2 |
| 17 | T3402 value | GPRS timer 9.9.3.16 | O | TV | 2 |
| 59 | T3423 value | GPRS timer 9.9.3.16 | O | TV | 2 |
| 4A | Equivalent PLMNs | PLMN list 9.9.2.8 | O | TLV | 5-47 |
| 34 | Emergency number list | Emergency number list 9.9.3.37 | O | TLV | 5-50 |
| 64 | EPS network feature support | EPS network feature support 9.9.3.12A | O | TLV | 3-4 |
| F- | Additional update result | Additional update result 9.9.3.0A | O | TV | 1 |
| 5E | T3412 extended value | GPRS timer 3 9.9.3.16B | O | TLV | 3 |
| 6A | T3324 value | GPRS timer 2 9.9.3.16A | O | TLV | 3 |
| 6E | Extended DRX parameters | Extended DRX parameters 9.9.3.46 | O | TLV | 3 |
| 65 | DCN-ID | DCN-ID 9.9.3.48 | O | TLV | 4 |
| E- | SMS services status | SMS services status 9.9.3.4B | O | TV | 1 |
| D- | Non-3GPP NW provided policies | Non-3GPP NW provided policies 9.9.3.49 | O | TV | 1 |
| 6B | T3448 value | GPRS timer 2 9.9.3.16A | O | TLV | 3 |
| C- | Network policy | Network policy 9.9.3.52 | O | TV | 1 |
| 6C | T3447 value | GPRS timer 3 9.9.3.16B | O | TLV | 3 |
| 7A | Extended emergency number list | Extended emergency number list 9.9.3.37A | O | TLV-E | 7-655 38 |
| 7C | Ciphering key data | Ciphering key data 9.9.3.56 | O | TLV-E | 35-22 91 |
| XX | Preferred SUPL server address list | SUPL server address list YY | O | TLV | 7-100 |

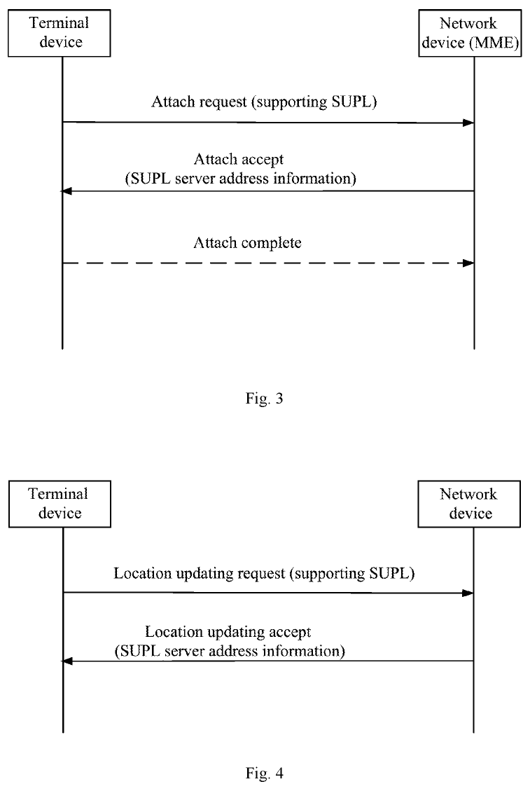

For a 2G/3G system, as shown in FIG. 4, the request message is a location updating request (LOCATION UPDATING REQUEST), and the response message is a location updating accept (LOCATION UPDATING ACCEPT).

For example, indication information is added to an IE MS network feature support of the LOCATION UPDATING REQUEST message to indicate that the terminal device supports assisted location, such as supporting an SUPL standard. A length of the indication information is, for example, 1 bit, as shown by an SUPL field in the following Table 6. For example, if the SUPL field is 1, it indicates that assisted location is supported; and if the SUPL field is 0, it indicates that assisted location is not supported.

TABLE 6

| 8 | 7 | 6 | 5 | 4 | 3 | 2 | 1 | |
|---|---|---|---|---|---|---|---|---|
| MS network feature support IEI | | | | 0 Spare | 0 Spare | SUPL | extended periodic timers | octet 1 |

For example, an IE is added to the LOCATION UPDATING ACCEPT, and the SUPL server address provided by the network side is sent to the terminal device, referring to the following Table 7. This situation is like the 5G system, and elaborations are omitted herein.

TABLE 7

| IEI | Information Element | Type/Reference | Presence | Format | Length (unit byte) |
|---|---|---|---|---|---|
| | Mobility management protocol discriminator | Protocol discriminator 10.2 | M | V | ½ |
| | Skip Indicator | Skip Indicator 10.3.1 | M | V | ½ |
| | Location Updating Accept message type | Message type 10.4 | M | V | 1 |
| | Location area identification | Location area identification 10.5.1.3 | M | V | 5 |
| 17 | Mobile identity | Mobile identity 10.5.1.4 | O | TLV | 3-10 |
| A1 | Follow on proceed | Follow on proceed 10.5.3.7 | O | T | 1 |
| A2 | CTS permission | CTS permission 10.5.3.10 | O | T | 1 |
| 4A | Equivalent PLMNs | PLMN list 10.5.1.13 | O | TLV | 5-47 |
| 34 | Emergency Number List | Emergency Number List 10.5.3.13 | O | TLV | 5-50 |
| 35 | Per MS T3212 | GPRS Timer 3 10.5.7.4a | O | TLV | 3 |
| D- | Non-3GPP NW provided policies | Non-3GPP NW provided policies 10.5.5.37 | O | TV | 1 |
| XX | Preferred SUPL server address list | SUPL server address list YY | O | TLV | 7-100 |

In an embodiment, there are specifically the following several scenarios when the terminal device interacts with the network device to obtain the address of the assisted location server after successful registration to the network device.

After the terminal device is successfully registered to the network device, parameters, such as the capability information of the terminal device in supporting SUPL and the address information of the assisted location server, may be transmitted between the terminal device and the network device by use of Protocol Configuration Options (PCO).

The following Table 8 shows part of contents of the PCO IE. In Table 8, an indication sent to the network device by the terminal device includes 0031H (SUPL server address request, i.e., SUPL SERVER ADDRESS REQUEST message), and an indication sent to the terminal device by the network device includes 0031H (SUPL server address information, i.e., SUPL Server Address List message).

TABLE 8

Additional parameters list (octets w+1 to z)
MS to network direction
- 0001H (P-CSCF IPv6 Address Request);
- 0002H (IM CN Subsystem Signaling Flag);
- 0003H (DNS Server IPv6 Address Request);
- 0004H (Not Supported);
- 0005H (MS Support of Network Requested Bearer Control indicator);
- 0006H (Reserved);
- 0007H (DSMIPv6 Home Agent Address Request);
- 0008H (DSMIPv6 Home Network Prefix Request);
- 0009H (DSMIPv6 IPv4 Home Agent Address Request);
- 000AH (IP address allocation via NAS signalling);
- 000BH (IPv4 address allocation via DHCPv4);
- 000CH (P-CSCF IPv4 Address Request);
- 000DH (DNS Server IPv4 Address Request);
- 000EH (MSISDN Request);
- 000FH (IFOM-Support-Request);
- 0010H (IPv4 Link MTU Request);
- 0011H (MS support of Local address in TFT indicator);
- 0012H (P-CSCF Re-selection support);
- 0013H (NBIFOM request indicator);
- 0014H (NBIFOM mode);
- 0015H (Non-IP Link MTU Request);
- 0016H (APN rate control support indicator);
- 0017H (3GPP PS data off UE status);
- 0018H (Reliable Data Service request indicator);
- 0019H (Additional APN rate control for exception data support indicator);
- 001AH (PDU session ID);
- 001BH (reserved);
- 001CH (Reserved);
- 001DH (Reserved);
- 001EH (Reserved);
- 001FH (Reserved);
- 0020H (Ethernet Frame Payload MTU Request);
- 0021H (Unstructured Link MTU Request);
- 0022H (5GSM cause value);
- 0023H (QoS rules with the length of two octets support indicator);
- 0024H (QoS flow descriptions with the length of two octets support indicator);
- 0025H (Reserved)
- 0026H (Reserved);
- 0027H (ACS information request);
-- 0028H (Reserved);
- 0029H (Reserved);
- 0030H (ATSSS request);
- 0031H (SUPL Server Address request): and
- FF00H to FFFFH reserved for operator specific use.

Network to MS direction:
- 0001H (P-CSCF IPv6 Address);
- 0002H (IM CN Subsystem Signaling Flag);
- 0003H (DNS Server IPv6 Address);
- 0004H (Policy Control rejection code);
- 0005H (Selected Bearer Control Mode);
- 0006H (Reserved);
- 0007H (DSMIPv6 Home Agent Address) ;
- 0008H (DSMIPv6 Home Network Prefix);
- 0009H (DSMIPv6 IPv4 Home Agent Address);
- 000AH (Reserved);
- 000BH (Reserved);
- 000CH (P-CSCF IPv4 Address);
- 000DH (DNS Server IPv4 Address);
- 000EH (MSISDN);
- 000FH (IFOM-Support);
- 0010H (IPv4 Link MTU);
- 0011H (Network support of Local address in TFT indicator);
- 0012H (Reserved);
- 0013H (NBIFOM accepted indicator);
- 0014H (NBIFOM mode);
- 0015H (Non-IP Link MTU);
- 0016H (APN rate control parameters);
- 0017H (3GPP PS data off support indication);
- 0018H (Reliable Data Service accepted indicator);
- 0019H (Additional APN rate control for exception data parameters);
- 001AH (reserved);
- 001BH (S-NSSAI);
- 001CH (QoS rules);
- 001DH (Session-AMBR);
- 001EH (PDU session address lifetime);
- 001FH (QoS flow descriptions);
- 0020H (Ethernet Frame Payload MTU);
- 0021H (Unstructured Link MTU);
- 0022H (Reserved);
- 0023H (QoS rules with the length of two octets);
- 0024H (QoS flow descriptions with the length of two octets);
- 0025H (Small data rate control parameters);
- 0026H (Additional small data rate control for exception data parameters);
- 0027H (ACS information);
- 0028H (Initial small data rate control parameters);
- 0029H (Initial additional small data rate control for exception data parameters);
- 0030H (ATSSS response with the length of two octets);
- 0031H (SUPL Server Address list): and
- FF00H to FFFFH reserved for operator specific use.

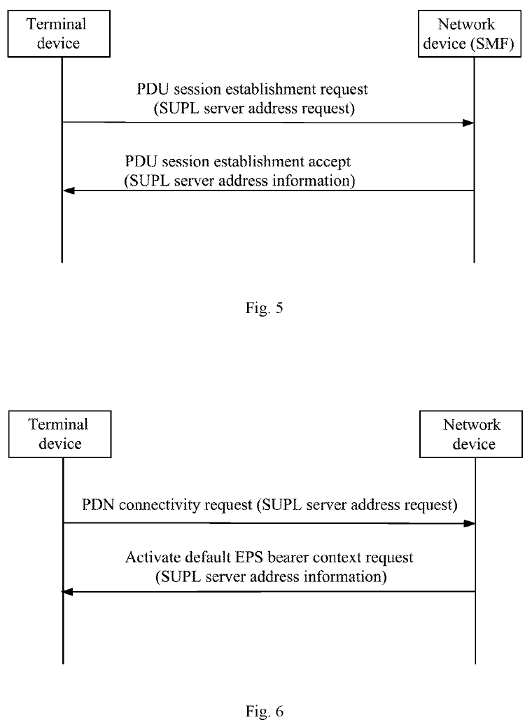

In an embodiment, for a 5G system, as shown in FIG. 5, the request message is a PDU session establishment request (PDU SESSION ESTABLISHMENT REQUEST) containing indication information of an SUPL server address request, such as including the capability information of supporting assisted location, and the response message is a PDU session establishment accept (PDU SESSION ESTABLISHMENT ACCEPT). The network device is, for example, an SMF unit.

For example, indication information is added to PCO of the PDU SESSION ESTABLISHMENT REQUEST message to indicate that the terminal device supports assisted location, such as supporting an SUPL standard.

For example, indication information is added to PCO of the PDU SESSION ESTABLISHMENT ACCEPT message to instruct the address of the assisted location server (such as the SUPL server address list) provided by the network side to be sent to the terminal device. A format of the SUPL server address list information may be similar to that in the above-mentioned Table 3, and will not be elaborated herein.

In an embodiment, for a 4G system, as shown in FIG. 6, the request message is a Public Data Network (PDN) connectivity request (PDN CONNECTIVITY REQUEST) containing indication information of an SUPL server address request, such as including the capability information of supporting assisted location, and the response message is an activate default Evolved Packet System (EPS) bearer context request (ACTIVATE DEFAULT EPS BEARER CONTEXT REQUEST).

For example, indication information is added to PCO of the PDN CONNECTIVITY REQUEST message to indicate that the terminal device supports assisted location, such as supporting an SUPL standard.

For example, indication information is added to PCO of the ACTIVATE DEFAULT EPS BEARER CONTEXT REQUEST message to instruct the address of the assisted location server (such as the SUPL server address list) provided by the network side to be sent to the terminal device. A format of the SUPL server address list information may be similar to that in Table 3, and will not be elaborated herein.

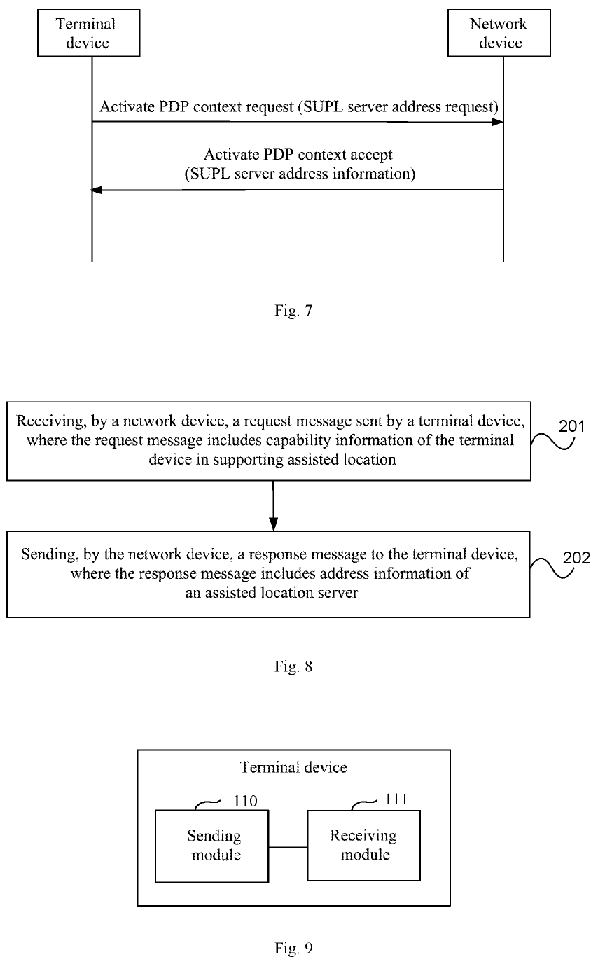

In an embodiment, for a 2G/3G system, as shown in FIG. 7, the request message is an activate Packet Data Protocol (PDP) context request (ACTIVATE PDP CONTEXT REQUEST) containing indication information of an SUPL server address request, such as including the capability information of supporting assisted location, and the response message is an activate PDP context accept (ACTIVATE PDP CONTEXT ACCEPT).

For example, indication information is added to PCO of the ACTIVATE PDP CONTEXT REQUEST message to indicate that the terminal device supports assisted location, such as supporting an SUPL standard.

For example, indication information is added to PCO of the ACTIVATE PDP CONTEXT ACCEPT message to instruct the address of the assisted location server (such as the SUPL server address list) provided by the network side to be sent to the terminal device. A format of the SUPL server address list information may be similar to that in Table 3, and will not be elaborated herein.

FIG. 8 is a schematic flowchart of another embodiment of a communication method according to the present disclosure. As shown in FIG. 8, the method provided in the present embodiment includes:

In S201, receiving, by a network device, a request message sent by a terminal device, where the request message includes capability information of the terminal device in supporting assisted location.

In S202, sending, by the network device, a response message to the terminal device, where the response message includes address information of an assisted location server.

In an embodiment, the assisted location follows an SUPL protocol.

In an embodiment, the receiving, by the network device, the request message sent by the terminal device includes:
receiving, by the network device, the request message sent by the terminal device during network registration; or,
receiving, by the network device, the request message sent by the terminal device after successful network registration.

In an embodiment, sending, by the network device, a response message to the terminal device includes:
sending, by the network device, the response message to the terminal device during network registration; or,
sending, by the network device, the response message to the terminal device after successful network registration.

In an embodiment, the address information of the assisted location server includes a length of the address information, an address of at least one assisted location server, and a length of the address of each assisted location server.

In an embodiment, the address information further includes priority information corresponding to each assisted location server.

An implementation principle and technical effects of the method of the present embodiment are similar to those of the embodiment corresponding to the terminal device side, and will not be elaborated herein.

FIG. 9 is a structural diagram of an embodiment of a terminal device according to the present disclosure. As shown in FIG. 9, the terminal device of the present embodiment includes:
a sending module 110, configured to send a request message to a network device, where the request message includes capability information of the terminal device in supporting assisted location; and
a receiving module 111, configured to receive a response message sent by the network device, where the response message includes address information of an assisted location server.

In a possible implementation, the sending module 110 is specifically configured to:
send the request message to the network device during network registration; or,
send the request message to the network device after successful network registration.

In a possible implementation, the receiving module 111 is specifically configured to:
receive the response message sent by the network device during network registration; or,
receive the response message sent by the network device after successful network registration.

In a possible implementation, the request message includes indication information, and the indication information is used for indicating that the terminal device supports assisted location.

In a possible implementation, the address information of the assisted location server includes a length of the address information, an address of at least one assisted location server, and a length of the address of each assisted location server.

In a possible implementation, the address information further includes priority information corresponding to each assisted location server.

In a possible implementation, the terminal device further includes:
a processing module, configured to determine address information of a target assisted location server according to the address information of the assisted location server, and
request the target assisted location server for assisted location data according to the address information of the target assisted location server.

In a possible implementation, the processing module is specifically configured to:

determine the address information of the target assisted location server according to the address of the at least one assisted location server and the priority information corresponding to each assisted location server.

In a possible implementation, the request message includes a PDU session establishment request message, and the sending module 110 is specifically configured to:

send the PDU session establishment request message to the network device after successful network registration.

In a possible implementation, the assisted location follows an SUPL protocol.

The terminal device of the present embodiment may be configured to perform the technical solution in the method embodiment corresponding to the terminal device side, and an implementation principle and technical effects thereof are similar to those of the method embodiment, and will not be elaborated herein.

The terminal device provided in the embodiment of the present disclosure may be a chip, a hardware module, a processor, etc. Certainly, the terminal device may be in other forms, and no limits are made thereto in the embodiment of the present disclosure.

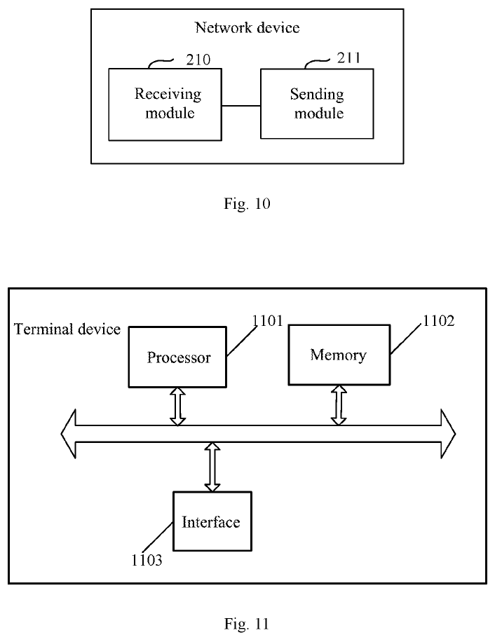

FIG. 10 is a structural diagram of an embodiment of a network device according to the present disclosure. As shown in FIG. 10, the network device of the present embodiment includes:
a receiving module 210, configured to receive a request message sent by a terminal device, where the request message includes capability information of the terminal device in supporting assisted location; and
a sending module 211, configured to send a response message to the terminal device, where the response message includes address information of an assisted location server.

In a possible implementation, the assisted location follows an SUPL protocol.

In a possible implementation, the receiving module 210 is specifically configured to:
receive the request message sent by the terminal device during network registration; or,
receive the request message sent by the terminal device after successful network registration.

In a possible implementation, the sending module 211 is specifically configured to:
send the response message to the terminal device during network registration; or,
send the response message to the terminal device after successful network registration.

In a possible implementation, the address information of the assisted location server includes a length of the address information, an address of at least one assisted location server, and a length of the address of each assisted location server.

In a possible implementation, the address information further includes priority information corresponding to each assisted location server.

The network device of the present embodiment may be configured to perform the technical solution in the method embodiment corresponding to the network device side, and an implementation principle and technical effects thereof are similar to those of the method embodiment, and will not be elaborated herein.

The network device provided in the embodiment of the present disclosure may be a chip, a hardware module, a processor, etc. Certainly, the network device may be in other forms, and no limits are made thereto in the embodiment of the present disclosure. FIG. 11 is a structural diagram of another embodiment of a terminal device according to the present disclosure. As shown in FIG. 11, the terminal device includes:

a processor 1101 and a memory 1102 configured to store an executable instruction for the processor 1101.

Optionally, the terminal device may further include an interface 1103, configured to implement communication with other devices.

The above-mentioned components may communicate through one or more buses.

The processor 1101 is configured to execute the executable instruction to perform the corresponding method in the method embodiment corresponding to the terminal device side, and a specific implementation process thereof may refer to the foregoing method embodiment, and will not be elaborated herein.

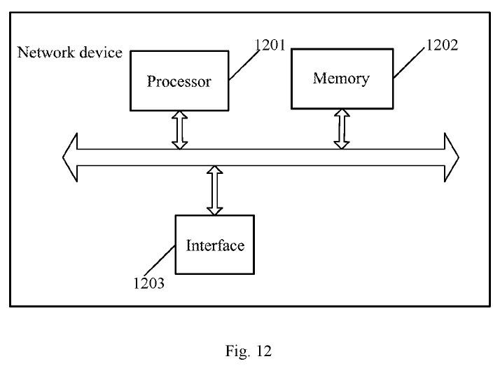

FIG. 12 is a structural diagram of another embodiment of a network device according to the present disclosure. As shown in FIG. 12, the network device includes:

a processor 1201 and a memory 1202 configured to store an executable instruction for the processor 1201.

Optionally, the network device may further include an interface 1203, configured to implement communication with other devices.

The above-mentioned components may communicate through one or more buses.

The processor 1201 is configured to execute the executable instruction to perform the corresponding method in the method embodiment corresponding to the network device side, and a specific implementation process thereof may refer to the method embodiment, and will not be elaborated herein.

An embodiment of the present disclosure also provides a computer-readable storage medium, storing a computer program which, when executed by a processor, implements the corresponding method in the above-mentioned method embodiment. A specific implementation process may refer to the method embodiment, and an implementation principle and technical effects thereof are similar to those of the method embodiment, and will not be elaborated herein.

An embodiment of the present disclosure also provides a program, which, when executed by a processor, is used for performing the technical solution in any one of the above-mentioned method embodiments.

Optionally, the processor may be a chip.

An embodiment of the present disclosure also provides a computer program product, including a program instruction for implementing the technical solution in any one of the above-mentioned method embodiments.

An embodiment of the present disclosure also provides a chip, including a processing module and a communication interface, where the processing module may perform the technical solution corresponding to the terminal device side in any one of the above-mentioned method embodiments.

Further, the chip further includes a storage module (such as a memory), configured to store an instruction. The processing module is configured to execute the instruction stored in the storage module. Execution of the instruction stored in the storage module enables the processing module to perform the technical solution corresponding to the terminal device side in any one of the above-mentioned method embodiments.

An embodiment of the present disclosure also provides a chip, including a processing module and a communication interface, where the processing module may perform the technical solution corresponding to the network device side in any one of the above-mentioned method embodiments.

Further, the chip further includes a storage module (such as a memory), configured to store an instruction, where the processing module is configured to execute the instruction stored in the storage module, and execution of the instruction stored in the storage module enables the processing module to perform the technical solution corresponding to the network device side in any one of the above-mentioned method embodiments.

Other implementations of the present disclosure are apparent to those skilled in the art upon considering the specification and practicing the disclosure disclosed herein. The present disclosure is intended to cover any transformations, uses, or adaptive variations of the present disclosure, and these transformations, uses, or adaptive variations follow the general principle of the present disclosure, and include common general knowledge or conventional technical means undisclosed in the present disclosure in this art. The specification and the embodiments are only regarded as examples, and the practical scope and spirit of the present disclosure are specified in the appended claims.

It is to be understood that the present disclosure is not limited to the precise structures described above and shown in the drawings, and various modifications and variations may be made without departing from the scope thereof. The scope of the present disclosure is only defined by the appended claims.

What is claimed is:

1. A communication method, comprising:
sending, by a terminal device, a request message to a network device, wherein the request message comprises capability information of the terminal device in supporting assisted location; and
receiving, by the terminal device, a response message sent by the network device, wherein the response message comprises address information of an assisted location server.

2. The method according to claim 1, wherein the sending, by the terminal device, the request message to the network device comprises:
sending, by the terminal device, the request message to the network device during network registration; or,
sending, by the terminal device, the request message to the network device after successful network registration.

3. The method according to claim 1, wherein the receiving, by the terminal device, the response message sent by the network device comprises:
receiving, by the terminal device, the response message sent by the network device during network registration; or,
receiving, by the terminal device, the response message sent by the network device after successful network registration.

4. The method according to claim 1, wherein
the request message comprises indication information, and the indication information is used for indicating that the terminal device supports assisted location.

5. The method according to claim 1, wherein the address information of the assisted location server comprises a length of the address information, an address of at least one assisted location server, and a length of the address of each assisted location server.

6. The method according to claim 5, wherein the address information further comprises priority information corresponding to each assisted location server.

7. The method according to claim 1, wherein after the receiving, by the terminal device, the response message sent by the network device, the method further comprises:
determining, by the terminal device, address information of a target assisted location server according to the address information of the assisted location server; and
requesting, by the terminal device, the target assisted location server for assisted location data according to the address information of the target assisted location server.

8. The method according to claim 7, wherein the determining, by the terminal device, address information of the target assisted location server according to the address information of the assisted location server comprises:
determining, by the terminal device, the address information of the target assisted location server according to the address of the at least one assisted location server and the priority information corresponding to each assisted location server.

9. The method according to claim 1, wherein the request message comprises a Protocol Data Unit (PDU) session establishment request message; and the sending, by the terminal device, the request message to the network device comprises:
sending, by the terminal device, the PDU session establishment request message to the network device after successful network registration.

10. The method according to claim 1, wherein the assisted location follows a Secure User Plane Location (SUPL) protocol.

11-13. (canceled)

14. A terminal device, comprising:
a processor, a memory, and an interface for communication with a network device; wherein
the memory stores a computer-executable instruction; and
the processor executes the computer-executable instruction stored in the memory to enable the processor to:
control the interface to send a request message to a network device, wherein the request message comprises capability information of the terminal device in supporting assisted location; and
control the interface to receive a response message sent by the network device, wherein the response message comprises address information of an assisted location server.

15. (canceled)

16. A non-transitory computer-readable storage medium, storing a computer-executable instruction which, when executed by a processor, is used for implementing following steps:
sending a request message to a network device, wherein the request message comprises capability information of the terminal device in supporting assisted location; and
receiving a response message sent by the network device, wherein the response message comprises address information of an assisted location server.

17. The terminal device according to claim 14, wherein the processor executes the computer-executable instruction stored in the memory to further enable the processor to:
control the interface to send the request message to the network device during network registration; or,
control the interface to send the request message to the network device after successful network registration.

18. The terminal device according to claim 14, wherein the processor executes the computer-executable instruction stored in the memory to further enable the processor to:
control the interface to receive the response message sent by the network device during network registration; or,
control the interface to receive the response message sent by the network device after successful network registration.

19. The terminal device according to claim 14, wherein
the request message comprises indication information, and the indication information is used for indicating that the terminal device supports assisted location.

20. The terminal device according to claim 14, wherein the address information of the assisted location server comprises a length of the address information, an address of at least one assisted location server, and a length of the address of each assisted location server.

21. The terminal device according to claim 20, wherein the address information further comprises priority information corresponding to each assisted location server.

22. The terminal device according to claim 14, wherein after the receiving the response message sent by the network device, the processor executes the computer-executable instruction stored in the memory to further enable the processor to:
determine address information of a target assisted location server according to the address information of the assisted location server; and
request the target assisted location server for assisted location data according to the address information of the target assisted location server.

23. The terminal device according to claim 22, wherein the processor executes the computer-executable instruction stored in the memory to further enable the processor to:
determine the address information of the target assisted location server according to the address of the at least one assisted location server and the priority information corresponding to each assisted location server.

24. The terminal device according to claim 14, wherein the request message comprises a Protocol Data Unit (PDU) session establishment request message; and wherein the processor executes the computer-executable instruction stored in the memory to further enable the processor to:
control the interface to send the PDU session establishment request message to the network device after successful network registration.
